(19) United States
(12) Patent Application Publication
(10) Pub. No.: US 2025/0154055 A1
(43) Pub. Date: May 15, 2025

(54) METHOD FOR PREPARING GENERAL-PURPOSE CEMENT BY CHLORINATION ROASTING OF ALUMINOSILICATES

(71) Applicants: HUNAN UNIVERSITY OF SCIENCE AND TECHNOLOGY, Xiangtan (CN); HUNAN XIANGCHU XIANLU ENVIRONMENTAL PROTECTION TECHNOLOGY CO., LTD., Changsha (CN)

(72) Inventors: Meixun PENG, Xiangtan (CN); Qiming ZHAO, Xiangtan (CN); Yuanpeng ZHANG, Xiangtan (CN); Wenwei LIU, Changsha (CN); Meilin CHEN, Changsha (CN)

(21) Appl. No.: 19/024,581

(22) Filed: Jan. 16, 2025

(30) Foreign Application Priority Data
Feb. 24, 2024 (CN) 202410204517.6

(51) Int. Cl. C04B 7/24; C04B 7/43; C04B 7/44; C04B 7/52; C04B 28/02; C04B 103/10

(52) U.S. Cl. CPC C04B 7/243; C04B 7/434; C04B 7/44; C04B 7/52; C04B 28/021; C04B 2103/10

(57) ABSTRACT

A method for preparing a general-purpose cement by chlorination roasting of aluminosilicates is provided, in which a mixture of aluminosilicates and sodium chloride is roasted in a steam atmosphere to obtain a roasted slag. The roasted slag is mixed with a material containing calcium oxide and magnesium oxide and ground to prepare a raw meal powder. The raw meal powder is subjected to oxidative calcination at a temperature not lower than 1240° C., followed by rapid cooling to obtain a calcined slag. The calcined slag is mixed with 0-3% by weight of caustic alkali and ground to obtain the general-purpose cement.

### CROSS-REFERENCE TO RELATED APPLICATIONS

This application claims the benefit of priority from Chinese Patent Application No. 202410204517.6, filed on Feb. 24, 2024. The content of the aforementioned application, including any intervening amendments made thereto, is incorporated herein by reference in its entirety.

### TECHNICAL FIELD

This application relates to solid waste treatment and cement-based building materials, and more particularly to a method for preparing a general-purpose cement by chlorination roasting of aluminosilicates.

### BACKGROUND

The rapid economic development is accompanied by a dramatic rise in the production of bulk solid wastes, which not only results in large occupation of land sources, but also may trigger serious geological disasters and cause soil, water and air pollutions. At present, the most effective method for recycling bulk solid wastes is to prepare building materials, such as general-purpose cement. The existing general-purpose cement is often produced by mixing a small amount of gypsum and other additives with Portland cement clinker. The bulk solid wastes are mostly aluminosilicates composed mainly of SiO₂ and Al₂O₃, and impurities contained therein such as alkali metal oxides and MgO are detrimental to the preparation of Portland cement clinker. Furthermore, metallurgical and mining waste residues often contain environmentally-harmful heavy metals, such that they cannot be directly used in the preparation of building materials. Considering the high-Ca low-Si/Al characteristic, the Portland cement clinker not only involves high carbon emission, but also struggles with poor utilization rate of aluminosilicate waste residues.

The development of low-carbon and environmentally-friendly general-purpose cement with high utilization capacity for silicate-aluminate waste residues as an alternative to the Portland cement has been a research focus in the cement industry. Alkali-activated cement features outstanding early strength, and excellent corrosion and freeze-thaw resistances, and its preparation can consume a large number of solid waste residues through a low-carbon, energy-saving, and environmentally-friendly process, making it one of the most promising alternatives to the Portland cement. Traditional alkali-activated cement is a two-component cement that is hardened by activating reactive amorphous (calcium) aluminosilicates with strong alkalis, and its preparation struggles with the following drawbacks: (1) Kaolin resources are scarce, and other major raw materials such as fly ash and blast furnace slag also experience a rise in price due to the excessive consumption as admixtures in the preparation of Portland cement; (2) the large consumption of industrial alkali activators (accounting for 3-14 wt. %, in Na₂O) results in high costs and makes the cement prone to efflorescence, which adversely affects its durability; and (3) the inherent compositional variability of industrial waste residues makes it difficult to achieve stable control and standardization of the performance and preparation process of alkali-activated cement made therefrom.

Reducing or eliminating the use of alkali activators can effectively lower the cost of alkali-activated cement. Chinese patent publications No. 110372240A and No. 110451827A disclose a preparation and application method for alkali-activated cement cured at room temperature and steam-cured alkali-activated cement, respectively, both including: mixing a small amount of industrial alkali with potassium sodium silicate-aluminate and calcareous raw materials, followed by grinding, calcination at 1250-1300° C., and rapid cooling to obtain a clinker; and finely grinding the clinker followed by uniform mixing with sodium silicate to obtain the desired cement. The cement pastes prepared thereby respectively have a 28-day compressive strength exceeding 80 MPa and 110 MPa. Though these methods reduce the consumption of the alkali activator compared to the preparation of common two-component alkali-activated cements, they still fail to reach the complete elimination of the alkali activator.

### SUMMARY

An object of the disclosure is to provide a method for preparing general-purpose cement with low carbon emission by chlorination roasting of aluminosilicates, by which sodium oxide is introduced into the cement.

Technical solutions of the present disclosure are described as follows.

A method for preparing a general-purpose cement by chlorination roasting of aluminosilicates, comprising:
(1) roasting a mixture of the aluminosilicates and sodium chloride in a steam atmosphere accompanied by fume discharge to obtain a solid roasted slag, wherein main chemical components of the aluminosilicates are SiO₂ and Al₂O₃;
(2) quantitatively mixing the solid roasted slag with a material containing CaO and MgO followed by grinding to obtain a powder mixture, or grinding the solid roasted slag followed by washing, drying, and mixing with a powder material containing CaO and MgO to obtain a powder mixture;
(3) subjecting the powder mixture to oxidative calcination at a temperature not lower than 1240° C. until a stable state with liquid phase dominated is formed, and cooling to obtain a calcined slag; and
(4) mixing the calcined slag with an alkali followed by grinding to obtain the general-purpose cement in a powder form, wherein the alkali is sodium hydroxide, solid potassium hydroxide or a combination thereof; or
grinding the calcined slag separately to obtain an active powder component of the general-purpose cement for storage, and mixing the active powder component with an aqueous solution of the alkali to produce a slurry of the general-purpose cement for use.

In some embodiments, in step (1), a steam flow rate is at least 60 g·min⁻¹·m⁻².

In some embodiments, in step (1), a maximum roasting temperature is 800-1000° C.

In some embodiments, in step (1), a holding time at a maximum roasting temperature is at least 1 h.

In some embodiments, in step (1), in a roasted slag produced from the aluminosilicates by oxidative calcination at 950° C., a total weight percentage of SiO₂, Al₂O₃, Fe₂O₃, CaO, MgO, Na₂O and K₂O is greater than 90.0%, and a weight ratio of SiO₂ to Al₂O₃ to Fe₂O₃ to CaO to MgO to a combination of Na₂O and K₂O is 49.0-82.5:10.0-46.0:0-8.1:0-5.0:0-9.5:0-12.2.

In some embodiments, the mixture of the aluminosilicates and sodium chloride in step (1) is produced through steps of:
mixing the aluminosilicates with sodium chloride followed by grinding and sieving with an 80-μm square-hole sieve.

In some embodiments, in step (1), the sodium chloride is 45.0% or less of a total weight of SiO₂ and Al₂O₃ in the aluminosilicates.

In some embodiments, in the calcined slag obtained in step (3), a weight ratio of SiO₂ to Al₂O₃ to Fe₂O₃ to CaO to MgO to a combination of Na₂O and K₂O is 30.0-42.0:10.0-17.0:0-6.0:22.0-46.0:0-16.0:3.1-8.3.

In some embodiments, in step (4), a mass of the alkali is calculated according to the following formula:

(NaOH+0.713KOH)/the calcined slag=0-3.0%.

In some embodiments, in step (1), a discharged fume is introduced into water for dissolution and collection, and a resultant aqueous solution is used to produce HCl gas or hydrochloric acid, or for recovering valuable metals.

Compared to the prior art, the present disclosure has the following beneficial effects.

(1) The sodium oxide is introduced by chlorination roasting of the aluminosilicates, such that the demand for alkali activator in the cement preparation is significantly reduced or eliminated, significantly reducing the cost of cement production.

(2) The prepared general-purpose cement uses aluminosilicates as the main raw material. Compared with Portland cement, the general-purpose cement provided herein significantly reduces the carbon emissions and effectively utilizes a large amount of aluminosilicate solid wastes.

(3) The content of alkali metal oxides in the cement clinker provided herein can be as low as 3.1%, with little or no alkali required for activation, which significantly reduces the occurrence of efflorescence in cement products. As a result, the cement durability is improved, and it can be used as decorative cement.

(4) Through the chlorination roasting process, valuable metals in mine tailings and metallurgical slags can be recovered. Meanwhile, the roasted slag can also be utilized for the cement preparation, thereby achieving the efficient and comprehensive utilization of solid wastes.

(5) Heavy metals in mine tailings and metallurgical slags can be removed through the chlorination roasting process, and the residual heavy metals can also be further solidified by using the roasted slag to prepare cement. Therefore, this application not only makes full use of heavy metal-containing solid wastes, but also effectively eliminates the risk of heavy metal pollution.

(6) The gas discharged during the chlorination roasting of aluminosilicates can be used to prepare HCl gas or hydrochloric acid.

### DETAILED DESCRIPTION OF EMBODIMENTS

The present disclosure will be described in detail below with reference to embodiments. It should be noted that the described embodiments are merely illustrative, and are not intended to limit the disclosure.

The embodiments are each described in three parts: chlorination roasting, raw meal calcination, and cement hydration and curing.

### (1) Chlorination Roasting

The aluminosilicate samples (dominated by SiO₂ and Al₂O₃) used herein included two kind of lead-zinc tailings, one kind of gold tailings, one kind of lithium tailings and eight kind of aluminosilicate rock mixtures. In addition to the common rock-forming element oxides, metal mine tailings also contained some valuable metals with a high recovery value. With respect to a calcined product obtained by oxidative calcination of each of the listed samples at 950° C., a total weight percentage of SiO₂+Al₂O₃+Fe₂O₃+CaO+MgO+Na₂O+K₂O was greater than 90.0%. A weight ratio of SiO₂ to Al₂O₃ to Fe₂O₃ to CaO to MgO to a combination of Na₂O and K₂O is 49.0-82.5:10.0-46.0:0-8.1:0-5.0:0-9.5:0-12.2. The dried aluminosilicates and sodium chloride were mixed and ground, where the sodium chloride accounted for 45.0% or less of a total weight of SiO₂ and Al₂O₃ in the aluminosilicates. Then, the fineness of the ground mixed powder was tested using an 80-μm square-hole sieve, and the mixed powder in the examples was sieved with the 80-μm square-hole sieve. Then, the ground mixed powder was transferred to a boat-shaped crucible and placed in a tubular atmosphere furnace. The temperature was increased at a rate of 5° C./min. When the temperature reached 500° C., steam was introduced, and when the temperature reached 800-1000° C., it was held for 1-4 h. The power was then turned off and the steam supply was terminated, and the intake pipe was connected to air. During roasting, a discharged fume was introduced into water for dissolution and continued until the roasted slag cooled to room temperature, after which the fume discharged was stopped. During roasting, a steam flow rate was at least 60 g·min⁻¹·m⁻² and could reach up to 700 g·min⁻¹·m⁻². The process parameters for each example were detailed in Table 1.

TABLE 1
Process parameters for chlorination roasting of aluminosilicates with sodium chloride

| | | Chemical composition of the | | | | | | | | | Maximum | | |
|---|---|---|---|---|---|---|---|---|---|---|---|---|---|
| | | aluminosilicates calcined slag ^{a} | | | | | | | | NaCl/ | roasting | Roasting | Steam |
| Roasting | Raw | (%) | | | | | | | | (SiO₂ + | temperature | time | flow |
| number | materials | SiO₂ | Al₂O₃ | Fe₂O₃ | CaO | MgO | Na₂O | K₂O | Others | Al₂O₃) | (° C.) | (h) | rate ^{b} |
| 1 | Metal tailing | 72.3 | 13.9 | 8.1 | 3.2 | 0.9 | 0.1 | 1.6 | 1.5 | 0.27 | 900 | 4 | 270 |
| 2 | | 64.1 | 28.4 | 4.3 | 1.7 | 0.5 | 0.1 | 0.9 | 2.7 | 0.25 | 950 | 2 | 270 |
| 3 | | 52.5 | 23.8 | 6.5 | 4.5 | 9.5 | 0.3 | 2.9 | 5.8 | 0.45 | 900 | 4 | 350 |
| 4 | | 77.6 | 12.2 | 3.1 | 2.1 | 0.8 | 2.0 | 2.2 | 4.6 | 0.45 | 900 | 4 | 410 |
| 5 | Aluminosilicates | 82.5 | 10.0 | 1.1 | 3.6 | 0.9 | 0.3 | 1.6 | 1.8 | 0.45 | 900 | 4 | 690 |
| 6 | mixed rock | 70.5 | 11.7 | 6.3 | 5.0 | 4.2 | 0.7 | 1.6 | 2.9 | 0.45 | 1000 | 1 | 700 |
| 7 | | 67.1 | 21.8 | 3.3 | 1.5 | 0.7 | 1.6 | 4.0 | 3.2 | 0.41 | 900 | 4 | 330 |
| 8 | | 79.6 | 15.2 | 0.7 | 1.0 | 0.3 | 1.7 | 1.5 | 4.1 | 0.37 | 800 | 4 | 280 |
| 9 | | 50.2 | 46.0 | 1.6 | 0.4 | 0.4 | 0.5 | 0.9 | 2.4 | 0.25 | 1000 | 2 | 60 |
| 10 | | 55.7 | 41.8 | 0.6 | 0.3 | 0.4 | 0.6 | 0.6 | 6.3 | 0.19 | 900 | 4 | 250 |
| 11 | | 49.0 | 30.8 | 7.0 | 0.2 | 0.8 | 0.6 | 11.6 | 1.0 | 0.33 | 900 | 4 | 250 |
| 12 | | 56.3 | 42.8 | 0.2 | 0.2 | 0.1 | 0.1 | 0.4 | 3.6 | 0.39 | 850 | 3 | 250 |

^{a} The content of each oxide was calculated based on SiO₂ + Al₂O₃ + Fe₂O₃ + CaO + MgO + Na₂O + K₂O as 100%.
^{b} Unit: g · min⁻¹ · m⁻²

When the aluminosilicates contained valuable metals and heavy metals, the chemical composition of the cooled roasted slag was analyzed. Based on the analysis results, the sodium chloride decomposition rate in each example (roasting number) was calculated to be 60-99.8%. Most of the sodium chloride was converted into Na₂O, which remained in the roasted slag. The content of residual Cl⁻ in the roasted slag was 0.25-6.67%. After chlorination roasting, various valuable metals in the metal tailings were effectively removed. The discharged fume solution could be recycled through subsequent physical and chemical treatments to recover valuable metals and heavy metals. The aluminosilicates without valuable metals and heavy metals were subjected to chlorination roasting to produce HCl gas, which was introduced into water through the discharged fume pipe for dissolution. After distillation and purification, commercial HCl gas or hydrochloric acid was obtained. The effects of chlorination roasting in each example were detailed in Table 2.

TABLE 2
Chlorination roasting effects

| | | | Decomposition | | Use of |
|---|---|---|---|---|---|
| | | | rate of sodium | | discharged |
| Roasting | Cl⁻ | Na₂O | chloride | | fume |
| number | (%) | (%) | (%) | Valuable metal content in roasted slag | solution |
| 1 | 0.25 | 10.6 | 99.8 | PbO 0.0155%, removal rate of 96.5%; | Recovery of |
| | | | | ZnO 0.023%, removal rate of 66.4% | valuable |
| 2 | 0.60 | 11.4 | 99.5 | PbO 0.0292%, removal rate of 87.2%; | metals |
| | | | | ZnO 0.019%, removal rate of 45.5% | |
| 3 | 4.09 | 17.4 | 68.0 | Au 0.3 ppm, removal rate of 65.3%; | |
| | | | | Cu 0.013%, removal rate of 91.2% | |
| 4 | 2.70 | 16.9 | 77.3 | Rb 0.021%, removal rate of 75.2%; | |
| | | | | Cs 0.095%, removal rate of 60.2% | |
| 5 | 1.51 | 16.3 | 84.9 | | Distillation |
| 6 | 2.80 | 16.7 | 76.9 | | to obtain |
| 7 | 6.67 | 16.4 | 60.6 | | HCl |
| 8 | 3.81 | 15.4 | 60.0 | | |
| 9 | 0.36 | 8.9 | 65.0 | | |
| 10 | 0.09 | 8.9 | 94.8 | | |
| 11 | 0.35 | 12.0 | 91.1 | | |
| 12 | 0.65 | 15.7 | 88.8 | | |

### (2) Raw Meal Calcination

The roasted slag obtained from each chlorination roasting example was mixed together with a raw material containing CaO and MgO and ground to obtain a powder mixture. The No. 7 roasted slag with high residual Cl⁻ content was ground into fine powder, washed with water, dried, and finally mixed evenly with other previously ground raw materials using a powder mixer. The other raw materials, excluding the roasted slag, included kaolin, analytical grade sodium carbonate, silicon dioxide (quartz powder), ferric oxide and natural dolomite powder. The chemical compositions of the raw materials were detailed in Table 3. The mixed powder was placed into a corundum crucible and transferred to a silicon carbide muffle furnace for calcination. The temperature was raised at a rate of 10° C./min. When the temperature reached 1240-1300° C., it was held for 1, 2, and 3 h, respectively. After the reaction was completed, the corundum crucible with the mixed powder was immediately removed from the muffle furnace and rapidly cooled by air blasting (air cooling) or water quenching (water cooling), so as to produce a calcined product mainly composed of a glass phase. A powder X-ray diffraction analysis revealed that varying the holding time during calcination of the same raw meal resulted in identical phase characteristics for clinker samples held for 2 h and 3 h, while samples held for 1 h showed some differences. Therefore, a holding time of 2 h at the maximum calcination temperature was adopted. The raw material formulations and the highest calcination temperature for each example were provided in Table 4. The calcined product was ground into fine powder to obtain a calcined material (clinker) powder. Chemical analysis showed that, in the calcined product, a weight ratio of SiO₂ to Al₂O₃ to Fe₂O₃ to CaO to MgO to a combination of Na₂O and K₂O is 30.0-42.0:10.0-17.0:0-6.0:22.0-46.0:0-16.0:3.1-8.3 (as shown in Table 5).

TABLE 3
Chemical composition of other raw materials used in cement raw meal formulation
(wt. %)

| | SiO₂ | Al₂O₃ | TFe₂O₃ | CaO | MgO | Na₂O | K₂O | Others |
|---|---|---|---|---|---|---|---|---|
| Kaolin | 42.7 | 38.3 | 0.5 | 0.3 | 0.3 | 0.5 | 0.6 | 16.7 |
| Dolomite | | | | 31.6 | 20.2 | | | 48.3 |
| Sodium carbonate | | | | | | 58.5 | | 41.5 |
| Calcium carbonate | | | | 56.0 | | | | 44.0 |
| Quartz | 99.9 | | | | | | | 0.1 |
| Ferric oxide | | | 99.9 | | | | | 0.1 |

TABLE 4
Cement raw meal formulation and calcination temperature (wt. %)

| | Raw material proportions (wt. %) | | | | | | | | |
|---|---|---|---|---|---|---|---|---|---|
| | Roasting | | | | | | | Calcination | |
| Calcination | slag ^{a} | | Sodium | Calcium | Quartz | Ferric | | temperature | Cooling |
| number | (number) | Kaolin | carbonate | carbonate | powder | oxide | Dolomite | (° C.) | method |
| 1 | 36.3(1) | 12.0 | | 10.0 | | 1.7 | 40.0 | 1300 | Air cooling |
| 2 | 50.0(2) | | | 10.0 | | | 40.0 | 1240 | Air cooling |
| 3 | 47(3) | | | 12.0 | 1.0 | | 40.0 | 1300 | Water |
| | | | | | | | | | cooling |
| 4 | 30.0(4) | 15.0 | | | | | 55.0 | 1300 | Air cooling |
| 5 | 30.0(5) | 16.0 | 3.0 | 10.0 | | 1.0 | 40.0 | 1300 | Air cooling |
| 6 | 44.0(6) | 8.0 | | | | | 48.0 | 1250 | Water |
| | | | | | | | | | cooling |
| 7 | 30.0(7)b | 9.0 | 3.0 | 58.0 | | | 0.0 | 1300 | Water |
| | | | | | | | | | cooling |
| 8 | 38.0(8) | 9.0 | 3.0 | 50.0 | | | 0.0 | 1260 | Water |
| | | | | | | | | | cooling |
| 9 | 24.6(9) | | 0.4 | 55.0 | 15.0 | | 5.0 | 1300 | Air cooling |
| 10 | 32.0(10) | | 3.0 | 50.0 | 10.0 | | 5.0 | 1300 | Water |
| | | | | | | | | | cooling |
| 11 | 32.0(11) | | | 50.0 | 13.0 | | 5.0 | 1300 | Water |
| | | | | | | | | | cooling |
| 12 | 32.0(12) | | 3.0 | 50.0 | 10.0 | | 5.0 | 1300 | Water |
| | | | | | | | | | cooling |

^{a} The weight of the No. 7 roasted slag was calculated based on the total content of SiO₂ + Al₂O₃ + Fe₂O₃ + CaO + MgO + Na₂O + K₂O.
^{b} The roasted slag was washed with water, dried and then used for batching.

### (3) Cement Hydration and Curing

The calcined product was ground into fine powder. NaOH and/or KOH were dissolved in a minimum amount of water and then cooled to room temperature. The amount of NaOH and/or KOH added was determined based on the following formula: (NaOH+0.713 KOH)/the calcined product=0-3.0%. The alkali solution was mixed with the clinker powder and stirred for 2-5 min, with an appropriate amount of water added to reduce the slurry consistency for subsequent liquefaction during vibration. Then, the slurry was poured into a 40×40×40 steel mold, vibrated for compaction, and placed in a standard cement curing chamber at 20° C. with a humidity of not less than 90% for 1 day. After curing was completed, the sample was demolded to obtain a cement paste sample. If the strength on the first day did not meet the demolding requirements, demolding was delayed. The specimens were then kept cured under humid conditions at room temperature until 3, 7 and 28 days, at which their unconfined compressive strength was tested. The cement paste formulation and compressive strength were detailed in Table 6. As shown in Table 6, it can be seen that the prepared clinker powder exhibited a certain self-gelling property, that was, it could solidify by simply adding water and showed relatively good compressive strength. As the alkali content increased, the strength of the cement showed an upward trend. The compressive strength of the cement paste at the 28^{th} day reached a maximum of nearly 100 MPa.

TABLE 5
Content of rock-forming oxides and chlorine residual in
calcined material (wt. %)

| Calcination | | | | | | | | |
|---|---|---|---|---|---|---|---|---|
| number | SiO₂ | Al₂O₃ | Fe₂O₃ | CaO | MgO | Na₂O | K₂O | Cl⁻ |
| 1 | 39.1 | 12.4 | 6.0 | 26.0 | 11.3 | 4.7 | 0.5 | 0.02 |
| 2 | 37.9 | 17.0 | 2.6 | 24.9 | 10.9 | 6.4 | 0.3 | 0.04 |
| 3 | 30.0 | 13.6 | 3.6 | 28.7 | 15.9 | 7.2 | 1.0 | 0.41 |
| 4 | 38.4 | 12.7 | 1.3 | 25.3 | 16.0 | 5.7 | 0.6 | 0.06 |
| 5 | 39.4 | 12.1 | 1.9 | 26.6 | 11.7 | 8.0 | 0.3 | 0.05 |
| 6 | 40.9 | 10.0 | 3.4 | 22.0 | 15.7 | 7.4 | 0.6 | 0.16 |
| 7 | 31.5 | 13.3 | 1.4 | 46.0 | 0.3 | 6.6 | 0.9 | 0.02 |
| 8 | 42.0 | 11.3 | 0.4 | 37.8 | 0.2 | 7.9 | 0.4 | 0.12 |
| 9 | 36.1 | 14.3 | 0.6 | 44.3 | 1.6 | 2.9 | 0.2 | 0.07 |
| 10 | 35.7 | 17 | 0.2 | 39.9 | 1.5 | 5.6 | 0.1 | 0.01 |
| 11 | 37.6 | 11.4 | 2.1 | 39.2 | 1.6 | 5.5 | 2.6 | 0.02 |
| 12 | 34.5 | 16.1 | 0.1 | 40.0 | 1.4 | 7.8 | 0.1 | 0.03 |

The oxide content was calculated based on the total content in SiO₂ + Al₂O₃ + Fe₂O₃ + CaO + MgO + Na₂O + K₂O.

TABLE 6
Cement paste formulation and compressive strength of paste samples

| | mass ratio to the | | | Compressive strength | | |
|---|---|---|---|---|---|---|
| | clinker powder | | | at different ages | | |
| Calcination | (wt. %) | | Liquid/solid | (MPa) | | |
| number | NaOH | KOH | mass ratio | 3-day | 7-day | 28-day |
| 1 | 0 | 0 | 0.29 | 0 | 5.4 | 18.9 |
| | 0.5 | 0.5 | 0.29 | 28.2 | 57.3 | 69.6 |
| | 1.0 | 1.0 | 0.29 | 57.6 | 70.1 | 94.2 |
| | 3.0 | 0 | 0.29 | 68.1 | 82.3 | 105.5 |
| 2 | 0 | 1.0 | 0.25 | 22.1 | 27.2 | 55.7 |
| | 2.0 | 0 | 0.25 | 27.3 | 34.9 | 67.0 |
| 3 | 0 | 1.0 | 0.25 | 28.7 | 40.1 | 49.9 |
| 4 | 0 | 0 | 0.25 | 1.2 | 2.5 | 12.0 |
| | 0 | 2.0 | 0.25 | 38.9 | 57.6 | 62.3 |
| 5 | 0 | 0 | 0.22 | 4.9 | 12.7 | 24.5 |
| | 1.0 | 1.0 | 0.22 | 23.4 | 47.9 | 64.5 |
| | 0 | 4.0 | 0.22 | 34.7 | 65.5 | 86.0 |
| 6 | 2.0 | 0 | 0.29 | 42.8 | 60.2 | 75.3 |
| 7 | 0 | 1.0 | 0.28 | 19.0 | 25.5 | 32.0 |
| | 0 | 3.0 | 0.29 | 38.9 | 49.2 | 64.8 |
| 8 | 1.0 | 0 | 0.27 | 11.5 | 19.4 | 26.5 |
| | 2.0 | 0 | 0.28 | 19.9 | 19.7 | 30.2 |
| 9 | 2.0 | 0 | 0.28 | 13.0 | 23.2 | 32.5 |
| 10 | 1.0 | 0 | 0.26 | 15.2 | 25.8 | 30.4 |
| 11 | 0.5 | 0 | 0.26 | 10.6 | 20.4 | 25.1 |
| 12 | 2.0 | 0 | 0.25 | 34.8 | 58.8 | 74.6 |

What is claimed is:

1. A method for preparing a general-purpose cement by chlorination roasting of aluminosilicates, comprising:
(1) roasting a mixture of the aluminosilicates and sodium chloride in a steam atmosphere followed by fume discharge to obtain a solid roasted slag, wherein main chemical components of the aluminosilicates are SiO₂ and Al₂O₃;
(2) quantitatively mixing the solid roasted slag with a material containing CaO and MgO followed by grinding to obtain a powder mixture, or
grinding the solid roasted slag followed by washing, drying, and mixing with a powder material containing CaO and MgO to obtain a powder mixture;
(3) subjecting the powder mixture to oxidative calcination at a temperature not lower than 1240° C. until a stable state with liquid phase dominated is formed, and cooling to obtain a calcined slag; and
(4) mixing the calcined slag with an alkali followed by grinding to obtain the general-purpose cement in a powder form, wherein the alkali is sodium hydroxide, potassium hydroxide or a combination thereof; or
grinding the calcined slag separately to obtain an active powder component of the general-purpose cement for storage, and mixing the active powder component with an aqueous solution of the alkali to produce a slurry of the general-purpose cement for use.

2. The method of claim 1, wherein in step (1), a steam flow rate is at least 60 g·min⁻¹·m⁻².

3. The method of claim 1, wherein in step (1), a maximum roasting temperature is 800-1000° C.

4. The method of claim 1, wherein in step (1), a holding time at a maximum roasting temperature is at least 1 h.

5. The method of claim 1, wherein in a slag produced from the aluminosilicates by oxidative calcination at 950° C., a total weight percentage of SiO₂, Al₂O₃, Fe₂O₃, CaO, MgO, Na₂O and K₂O is greater than 90.0%, and a weight ratio of SiO₂ to Al₂O₃ to Fe₂O₃ to CaO to MgO to a combination of Na₂O and K₂O is 49.0-82.5:10.0-46.0:0-8.1:0-5.0:0-9.5:0-12.2.

6. The method of claim 1, wherein the mixture of the aluminosilicates and sodium chloride in step (1) is produced through steps of:
mixing the aluminosilicates with sodium chloride followed by grinding and sieving with an 80-μm square-hole sieve.

7. The method of claim 1, wherein in step (1), the sodium chloride is 45.0% or less of a total weight of SiO₂ and Al₂O₃ in the aluminosilicates.

8. The method of claim 1, wherein in the calcined slag obtained in step (3), a weight ratio of SiO₂ to Al₂O₃ to Fe₂O₃ to CaO to MgO to a combination of Na₂O and K₂O is 30.0-42.0:10.0-17.0:0-6.0:22.0-46.0:0-16.0:3.1-8.3.

9. The method of claim 1, wherein in step (4), a mass of the alkali is calculated according to the following formula:
(NaOH+0.713KOH)/the calcined slag=0-3.0%.

10. The method of claim 1, wherein in step (1), a discharged fume is introduced into water for dissolution and collection, and a resultant aqueous solution is used to produce HCl gas or hydrochloric acid, or for recovering valuable metals.
